(19) United States
(12) Patent Application Publication
(10) Pub. No.: US 2013/0140460 A1
(43) Pub. Date: Jun. 6, 2013

(54) PORTABLE RADIATION DETECTION UNIT

(71) Applicant: CANON KABUSHIKI KAISHA, Tokyo (JP)

(72) Inventor: Masaaki Kobayashi, Shimotsuke-shi (JP)

(73) Assignee: CANON KABUSHIKI KAISHA, Tokyo (JP)

(21) Appl. No.: 13/681,808

(22) Filed: Nov. 20, 2012

(30) Foreign Application Priority Data
Dec. 6, 2011 (JP) 2011-267259

(51) Int. Cl. G01T 1/16

(52) U.S. Cl. CPC G01T 1/16
USPC 250/336.1

(57) ABSTRACT

A portable radiation detection unit comprises a radiation detection panel that detects radiation and a housing that contains the radiation detection panel, wherein the housing comprises a first housing portion, which includes at least one sidewall, and a second housing portion, which is independent from the first housing portion, and by using a configuration in which the first housing portion is movable with respect to the second housing portion, a distance between the sidewall of the first housing portion and an end portion of the radiation detection panel provided in the second housing portion is variable.

### BACKGROUND OF THE INVENTION

1. Field of the Invention

The present invention relates to portable radiation detection units.

2. Description of the Related Art

In recent years, digital radiation imaging devices that directly digitize radiation images have become commonplace using so-called flat panel detectors (FPD), which are radiation detection panels in which a fluorescent material and a large-area solid-state image sensing element are closely attached. With portable digital radiation imaging devices, which are referred to as electronic cassettes, digital radiation image data is outputted promptly after imaging and can be confirmed on a display while maintaining the advantage of being able to be commonly used in imaging in radiation imaging chambers and medical wards in a same manner as conventional film cassettes and CR cassettes. Japanese Patent No. 4497663 discloses a structure in which a shock absorbing member for absorbing shock to a base (chassis) in a direction parallel to a detection surface and a space are provided internally. Further still, by providing electrical circuitry for processing image signals obtained from the radiation detection panel at a rear surface side of the radiation detection panel, a slimmer bezel is achieved and it becomes easier to perform imaging at regions close to the surface of an object.

Furthermore, Japanese Patent Laid-Open No. 2002-143138 discloses a structure in which a radiation detection panel is secured on a support base and the support base moves within a housing along with the radiation detection panel.

However, in the case of using a structure where a much slimmer bezel has been implemented, the distance between the side surface of the electronic cassette housing and the end portion of the radiation detection panel is reduced and there is a risk that the panel will break if a load is applied. In the case of using a structure in which strength is given priority, the distance between the side surface of the housing and the end portion of the radiation detection panel is increased due to the shock absorbing member and the space, and therefore it becomes difficult to perform imaging of regions close to the object.

In the case of providing a mechanism for moving the panel with respect to the housing as in Japanese Patent Laid-Open No. 2002-143138, there is a problem in that the size of the electronic cassette increases due to the presence of this mechanism. Furthermore, this is not a structure intended to achieve a slimmer bezel.

### SUMMARY OF THE INVENTION

In light of these issues, the present invention provides a portable radiation detection unit capable of supporting both portable imaging in which shock resistance is required and imaging in which a slim bezel is required.

According to one aspect of the present invention, there is provided a portable radiation detection unit comprising a radiation detection panel that detects radiation and a housing that contains the radiation detection panel, wherein the housing comprises a first housing portion, which includes at least one sidewall, and a second housing portion, which is independent from the first housing portion, and by using a configuration in which the first housing portion is movable with respect to the second housing portion, a distance between the sidewall of the first housing portion and an end portion of the radiation detection panel provided in the second housing portion is variable.

Further features of the present invention will be apparent from the following description of exemplary embodiments with reference to the attached drawings.

### BRIEF DESCRIPTION OF THE DRAWINGS

FIG. 1 is a configuration diagram of a portable radiation detection unit according to a first embodiment.

FIG. 2 is a vertical cross-sectional view of the portable radiation detection unit according to the first embodiment and shows a state prior to a sidewall moving.

FIG. 3 is an explanatory diagram of a lock mechanism unit of the portable radiation detection unit according to the first embodiment.

FIG. 4 is an explanatory diagram of a side surface of the lock mechanism unit of the portable radiation detection unit according to the first embodiment.

FIG. 5 is a diagram showing a state of the portable radiation detection unit of FIG. 1 after the sidewall has moved.

FIG. 6 is a diagram showing a state after the sidewall has moved in a vertical cross-sectional view of the portable radiation detection unit of FIG. 2.

FIG. 7 is a diagram showing a modified example of the portable radiation detection unit according to the first embodiment and shows a state prior to the movable housing unit moving.

FIG. 8 is a diagram showing a modified example of the portable radiation detection unit according to the first embodiment and shows a state after the movable housing unit has moved.

FIG. 9 is a diagram showing a positional relationship of the radiation detection panel, a flexible printed circuit board (FPC), and the movable housing unit when the radiation image sensing unit of the portable radiation detection unit according to the first embodiment is viewed from a radiation incident surface side.

FIG. 10 is a configuration diagram of a portable radiation detection unit according to a second embodiment.

FIG. 11A to FIG. 11D are diagrams for describing attaching of the radiation image sensing unit to an accommodation unit in the portable radiation detection unit according to the second embodiment.

FIG. 12 is a configuration diagram of a portable radiation detection unit according to a third embodiment.

FIG. 13 is a configuration diagram of a conventional radiation detection unit.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

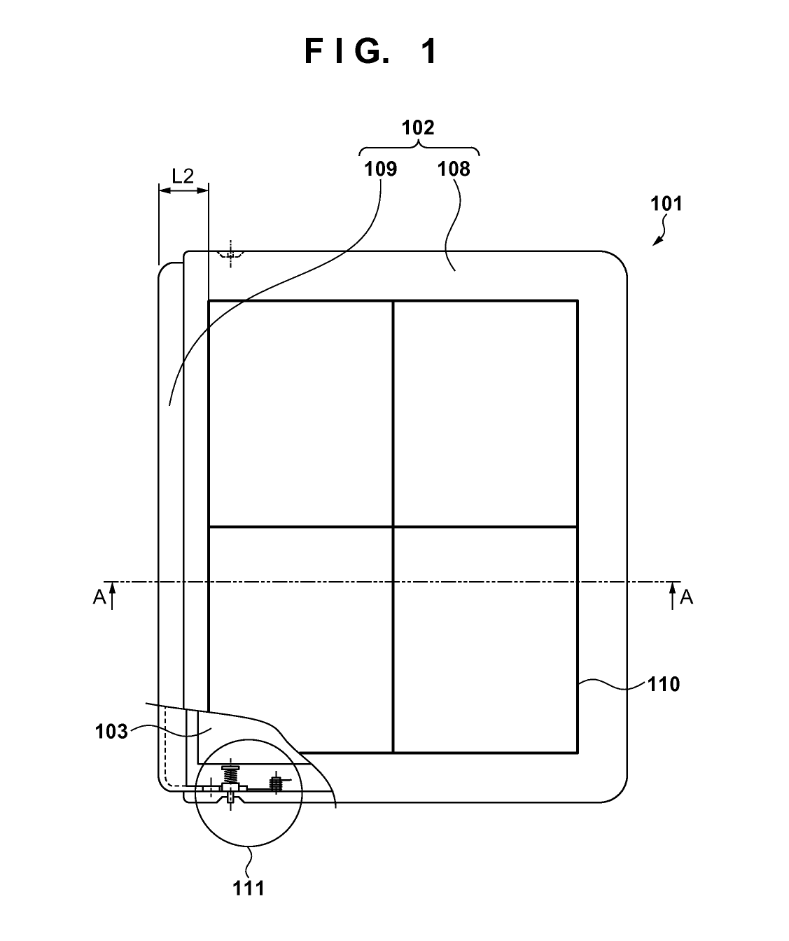

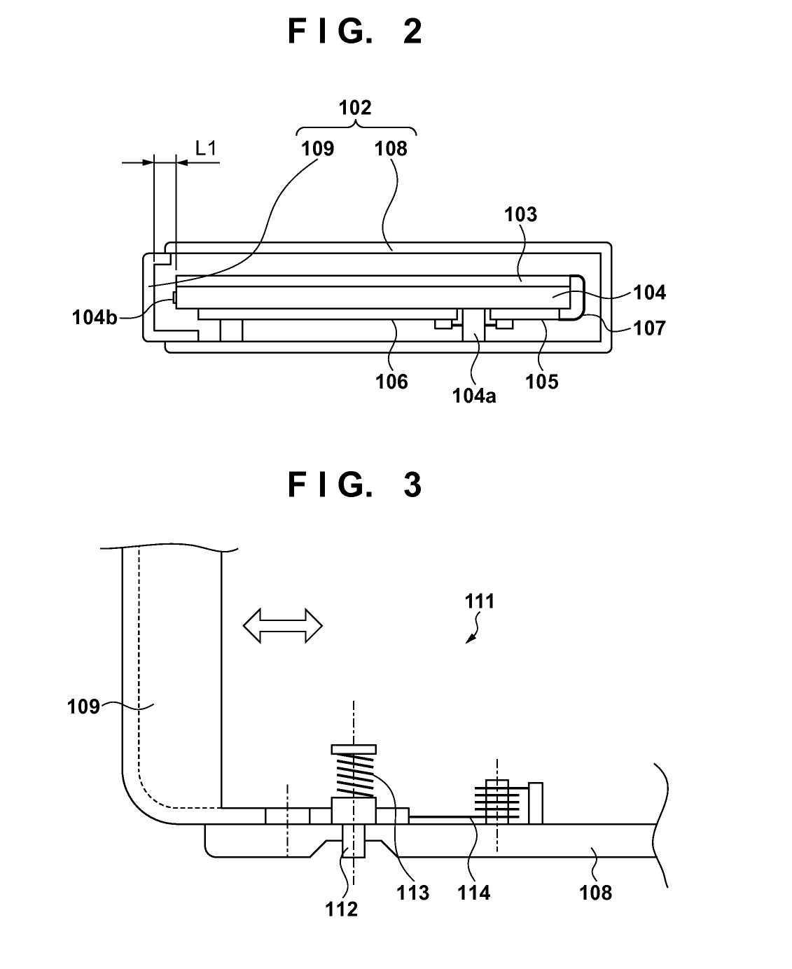

Description is given of a first embodiment of the present invention with reference to FIGS. 1 to 9. FIG. 1 is a diagram showing a radiation image sensing unit 101 of a portable radiation detection unit according to the first embodiment as viewed from a radiation incident surface side. FIG. 2 shows an A-A cross-sectional view of FIG. 1. It should be noted that same reference symbols are assigned to same compositional elements throughout this specification and duplicate description thereof is omitted.

A portable radiation image sensing unit 101 accommodates a radiation detection panel 103, a chassis 104, and electronic substrates 105 and 106 inside a housing 102. The radiation detection panel 103 has conversion elements that generate electrical signals in accordance with amounts of incident radiation. The chassis 104 is a panel support structure that supports the radiation detection panel 103 and is provided with leg units 104a at multiple locations on an opposite surface to the surface that supports the radiation detection panel 103, and these leg units 104a are joined to an inner wall of the housing 102. At least one end portion of four end portions of the radiation detection panel 103, which is substantially of a rectangular shape, is connected to a flexible printed circuit board (FPC) 107, and other end portions of the FPC 107 are connected to the electronic substrate 105 that is arranged in a space provided between the chassis 104 and the housing 102 due to the leg units 104a.

Next, description is given regarding a structure of the housing 102, which is a feature of the present invention. The housing 102 is provided with a secured housing unit 108 and a movable sidewall unit 109. The secured housing unit 108 is a second housing portion that is independent from the movable sidewall unit 109, which is a first housing portion. By using a configuration in which the movable sidewall unit 109 is movable with respect to the secured housing unit 108, the distance between the housing inner wall (sidewall) of the movable sidewall unit 109 and the end portion of the radiation detection panel 103 provided in the secured housing unit 108 is variable.

The secured housing unit 108 is formed as a box shape with one end open and, as mentioned before, contains and secures the radiation detection panel 103 and the chassis 104 that supports the radiation detection panel 103. At least a front surface region of the secured housing unit 108 that corresponds to an incident radiation region is constituted by a material having good radiolucency properties such as CFRP (carbon fiber reinforced plastic) or the like. In the present embodiment, the secured housing unit 108 is illustrated as an integral casting using a lightweight, high-rigidity member such as CFRP, but this can also be configured by inlaying a CFRP panel in a portion corresponding to the incident radiation region and using a metal material such as a magnesium alloy for example for other portions. Furthermore, from a perspective of workability and ease of assembly, the secured housing unit 108 may also be a configuration of multiple segmented members. As shown in FIG. 1, a frame line 110 is demarcated on the radiation incident surface of the secured housing unit 108, and this makes it easier to visually distinguish the region in which imaging is possible.

On the other hand, as shown in FIG. 2, the movable sidewall unit 109 is internally in contact with the opening of the secured housing unit 108, and by combining the secured housing unit 108 and the movable sidewall unit 109, accommodated components such as the radiation detection panel 103 are hermetically sealed. The movable sidewall unit 109 and the secured housing unit 108 slide against each other at a contact area, thereby making the position of the movable sidewall unit 109 variable with respect to the secured housing unit 108. In a state of portable imaging, the movable sidewall unit 109 is secured to the secured housing unit 108 maintaining a space L1 from the end portion of the radiation detection panel 103 to the inner wall of the movable sidewall unit 109. The space L1 is a distance that mitigates damage to the radiation detection panel 103 from deformation and positional displacement caused by external force exerted on the radiation image sensing unit 101, and is obtained through simulation or testing of an actual device. It should be noted that in this state, the distance from the outer end of the radiation image sensing unit 101 to the region in which imaging is possible is L2 as shown in FIG. 1.

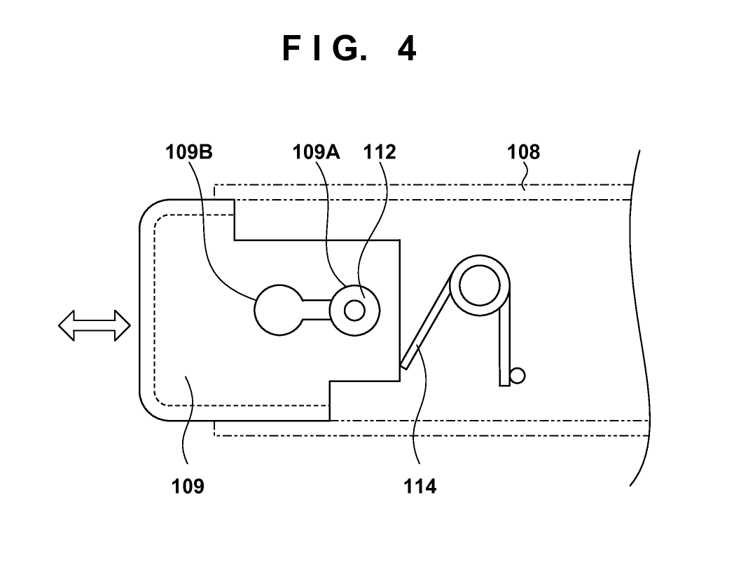

The securing of the movable sidewall unit 109 to the secured housing unit 108 is carried out using a lock mechanism unit 111 shown in FIG. 1. FIG. 3 is a detailed explanatory diagram of the lock mechanism unit 111 shown in FIG. 1, and FIG. 4 is a diagram of the lock mechanism unit 111 as viewed laterally. A lock pin 112 fits into a hole provided at the sidewall of the secured housing unit 108. The lock pin 112 is a stepped shaft having two diameters, and due to pressing by a spring 113, a shorter diameter portion of the lock pin 112 protrudes from the inner side of the sidewall of the secured housing unit 108. On the other hand, two holes 109A and 109B into which a longer diameter portion of the lock pin 112 fits are provided on the side surface of the movable sidewall unit 109. The relative positional relationship between the movable sidewall unit 109 and the secured housing unit 108 switches by selectively fitting the longer diameter portion of the lock pin 112 into the hole 109A or the hole 109B. In a state of portable imaging, the longer diameter portion of the lock pin 112 fits into the hole 109A and is secured in a state in which the distance L1 between the radiation detection panel 103 and the housing inner wall is maintained. As described earlier, with this positional relationship, the structure is highly safe against impact to the radiation image sensing unit 101.

In the case of changing the radiation image sensing unit 101 to a slim bezel state, the lock pin 112 that protrudes from the sidewall of the secured housing unit 108 is pushed to the inner side. By doing this, the longer diameter portion of the lock pin 112 comes out of the hole 109A such that the movable sidewall unit 109 goes into a slidable state. In this state, the movable sidewall unit 109 is pressed into the direction of the secured housing unit 108. The movable sidewall unit 109 moves until a position where its inner wall knocks against a stopper unit 104b (FIG. 2) provided on the chassis 104. At this position, the lock pin 112 fits into the hole 109B next to the hole 109A, and the movable sidewall unit 109 is again secured against the secured housing unit 108.

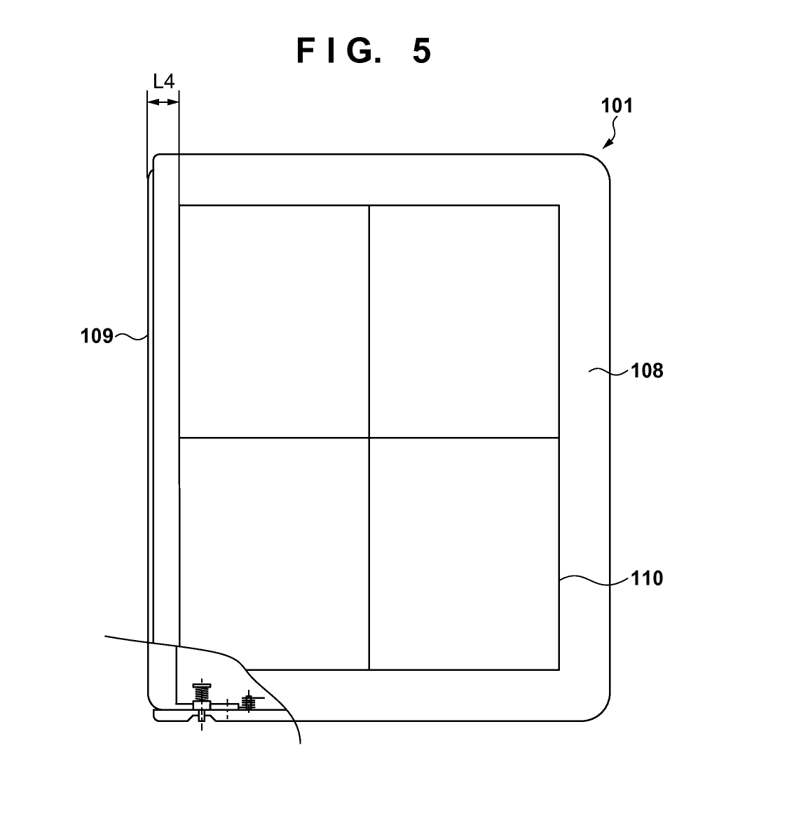

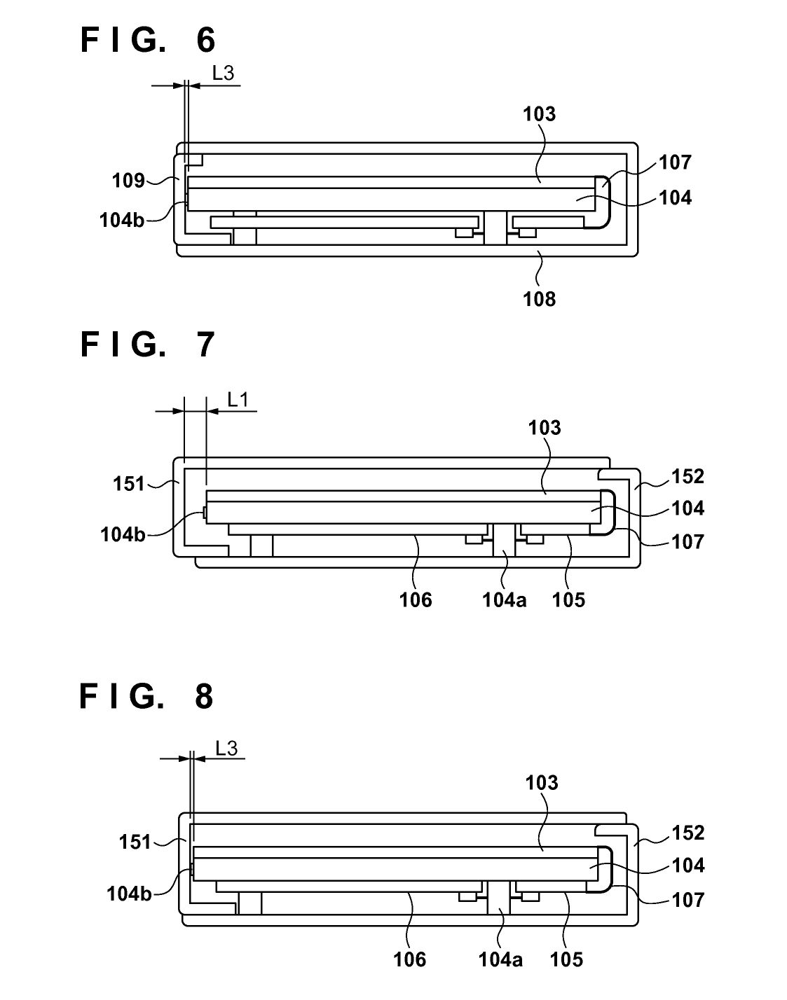

Here, FIG. 5 and FIG. 6 are diagrams showing states of the radiation image sensing unit 101 after the movable sidewall unit 109 has moved from the states shown in FIG. 1 and FIG. 2 respectively. Due to this movement, the gap narrows between the end portion of the radiation detection panel 103 and the inner wall of the movable sidewall unit 109 so as to become the distance L3 shown in FIG. 6. In this state, the distance from the outer end of the radiation image sensing unit 101 to the imaging region shortens from L2 prior to movement to L4 as shown in FIG. 5, and imaging becomes possible up to a near-distance position from the end portion of the radiation image sensing unit 101. As mentioned earlier, it should be noted that the FPC 107 is connected to at least one end of the radiation detection panel 103. In the present embodiment, by not placing the FPC 107 on the movable sidewall unit 109 side, a structure is achieved in which the housing 102 and the radiation detection panel 103 can be brought closer to each other. That is, of the four end portions of the radiation detection panel, the flexible printed circuit board is not connected to the end portion of the radiation detection panel where the distance is variable, and the flexible printed circuit board is connected to at least one of the other remaining end portions.

Furthermore, in the present embodiment, illustration is given showing the end portions of the radiation detection panel 103 and the chassis 104 as being aligned, but it is also possible to use an arrangement in which the radiation detection panel 103 protrudes or retracts from the chassis 104 matching the shape of the inner wall of the movable sidewall unit 109.

In the case of changing again from the slim bezel state to the state for portable use, by pushing the lock pin 112 to release its securing, the movable sidewall unit 109 is configured so as to be biased due to the biasing force of the spring 114 (elastic member) and returns naturally to the position shown in FIG. 1 and FIG. 2. It should be noted that the present embodiment is illustrated using a configuration in which the initial state is the portable state, but a configuration can be achieved in which the slim bezel state is the initial state by changing the placement of the spring 114 and the like.

By having a configuration in which the position of the sidewall can be switched in this way, a single imaging device is able to achieve both a form having shock resistance required for portable use and a form having a slim bezel required in mammography and the like.

Description is given with reference to FIG. 7 and FIG. 8 of a modified example of the radiation image sensing unit 101 of the portable radiation detection unit according to the first embodiment. FIG. 7 is a diagram showing a state prior to the movable housing unit moving, and FIG. 8 is a diagram showing a state after the movable housing unit has moved.

Up to this point, a configuration has been shown in FIG. 1 to FIG. 6 in which only one sidewall of the housing moves, but a point of difference in FIG. 7 and FIG. 8 is that the member constituting the incident radiation region is integrated with the sidewall and moves.

In FIG. 7, a movable housing unit 151 includes at least one sidewall and a housing configuration wall having a radiation incident surface. A secured housing unit 152 is a housing unit for securing at least the radiation detection panel. A same configuration as FIG. 2 can be used for other aspects of the configuration.

FIG. 8 shows a state after the movable housing unit 151 has been moved. By using a configuration constituted by a uniform member having good radiolucency properties such as CFRP or the like from the radiation incident surface of the movable housing unit 151 to a corner area where the sidewall and the radiation incident surface join, it is possible to provide a housing that enables imaging right up to the sidewall. At the same time as this, by having an imaging-capable region of the radiation detection panel 103 up to the vicinity of the panel end and using the radiation detection panel 103 to which the FPC 107 is connected on an opposite side, a radiation image sensing unit 101 can be provided having an extremely short distance from its outer end to the imaging-capable region.

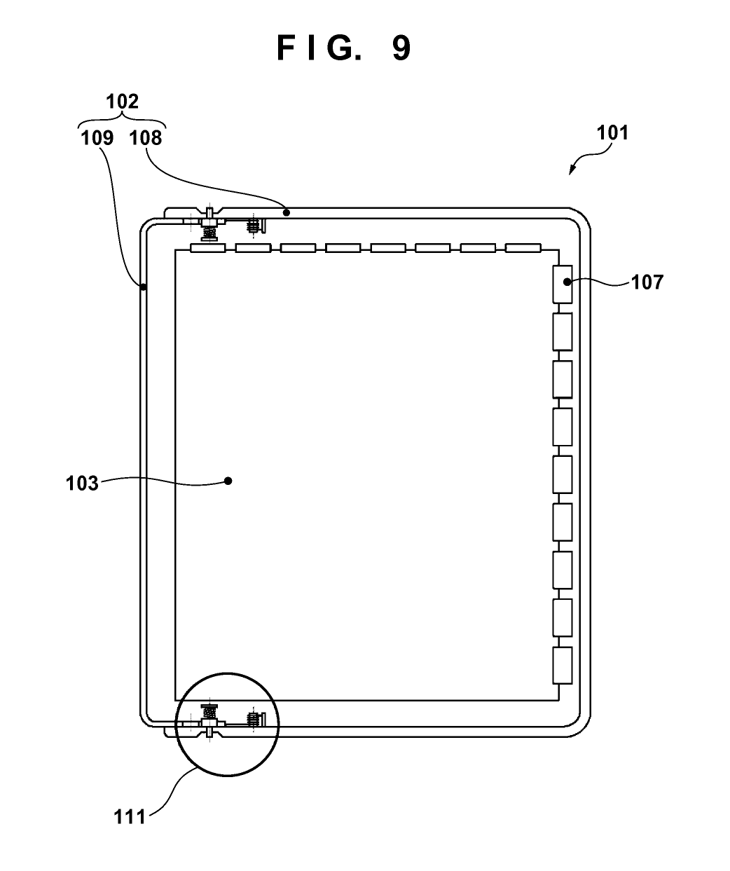

Description is given with reference to FIG. 9 regarding a positional relationship of the radiation detection panel 103, the flexible printed circuit board (FPC) 107, and the movable housing unit 151 when the radiation image sensing unit 101 is viewed from the radiation incident surface side.

An unshown drive circuit connects along a short edge of the radiation detection panel 103 through the flexible printed circuit board 107. It provides a drive signal for driving the number of pixels contained in the radiation detection panel 103 and reading out pixel signals that are outputted in accordance with the detection of radiation. For each row or each pixel, the drive circuit connects a pixel and a readout signal line, and applies a pixel signal to the readout signal line.

An unshown amplifier connects along a long edge of the radiation detection panel 103 through the flexible printed circuit board (FPC) 107. It amplifies the pixel signals that are read out through the readout signal line. An unshown AD convertor connects to the amplifier and converts the amplified pixel signals at a predetermined rate from analog signals to digital signals.

The drive circuit as well as the amplifier and the AD convertor are arranged along the edges of the radiation detection panel at a rear surface side of the radiation detection panel 103 as viewed from the radiation incident surface. The drive circuit, the amplifier, and the AD convertor are connected using the radiation detection panel 103 and the flexible printed circuit board (FPC).

The drive circuit is arranged along a short edge of the rectangular radiation detection panel 103, and the amplifier and the AD convertor are arranged along at least one edge of the long edges of the radiation detection panel. It should be noted that if these are provided along two opposing edges, the pixel signals handled by a single amplifier and AD convertor become fewer compared to a case of providing these on one edge. Accordingly, in this case, the readout speed can be improved.

Here, neither the drive circuit nor the amplifier is arranged on an edge along the movable housing unit 151. Due to this, it is possible to avoid the occurrence of problems such as breakage by a load being applied to the FPC or connecting end portions thereof due to movement. Furthermore, the FPC and connecting end portions thereof do not come to the side of the movable housing unit 151, and therefore the margin between the border of the housing and the detection region of the radiation panel is reduced, which has the advantage of facilitating imaging at positions close to the object.

### Second Embodiment

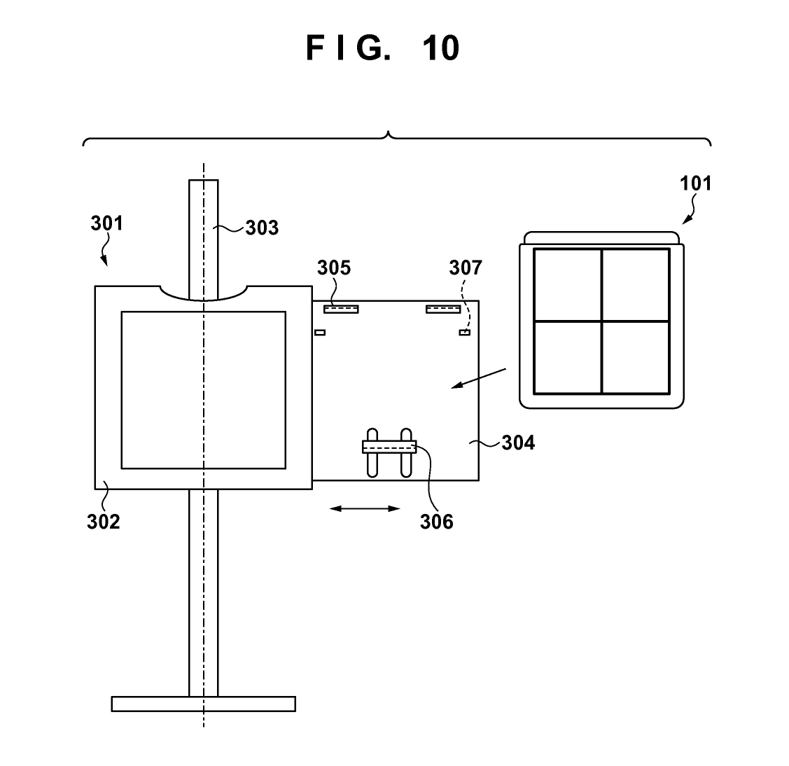

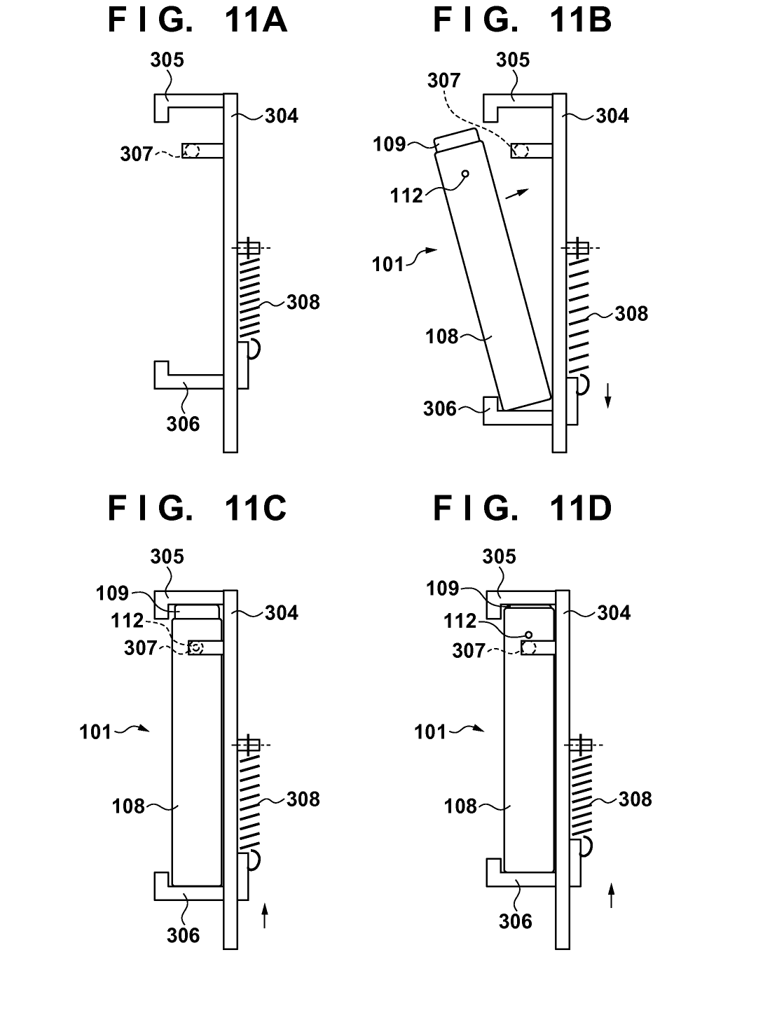

Description is given of a second embodiment of the present invention with reference to FIG. 10 and FIGS. 11A to 11D. In the second embodiment, an accommodation unit is added to the configuration to detachably accommodate the entire housing in which the radiation image sensing unit is contained. For example, the accommodation unit corresponds to a generally used upright stand or a cassette mounting unit in a mammography device. In comparison to the first embodiment, in the second embodiment a point of difference is that the varying of the gap between the housing sidewall of the radiation image sensing unit 101 and the radiation detection panel 103 is configured so as to be carried out by working in cooperation with the attaching and detaching of the radiation image sensing unit 101 to the accommodation unit. That is, in a state in which the housing is mounted in the accommodation unit and the first housing portion is being pressed by the accommodation unit, the first housing portion moves so that the sidewall of the first housing portion and the end portion of the radiation detection panel achieve a first distance and the housing is taken out from the accommodation unit, and in a state in which the first housing portion is not being pressed by the accommodation unit, the first housing portion moves to achieve a second distance which is longer than the first distance due to the biasing force of the elastic member.

FIG. 10 shows a configuration example in which the radiation image sensing unit 101 according to the present embodiment is inserted into an upright stand. In FIG. 10, an upright imaging device 301 is provided with an accommodation unit 302 and a support prop 303. The accommodation unit 302 is movable in a vertical direction and is used by being positioned to match an examination position of an examinee. The accommodation unit 302 has a withdrawable tray 304, and imaging is carried out in a state in which the portable-use radiation image sensing unit 101 is attached here and accommodated. Furthermore, the tray 304 is provided with an upper unit securing panel 305, a lower unit securing panel 306, and a lock release shaft 307.

FIG. 11A to FIG. 11D are diagrams in which the tray 304 is observed laterally. The upper unit securing panel 305 is secured to the tray 304, and the lower unit securing panel 306 is attached so as to be movable in upward and downward directions with respect to the tray 304. Furthermore, due to an elastic force of a spring 308 arranged at a rear surface of the tray 304, an uplifting force works in an upward direction on the lower unit securing panel 306.

Description is given with reference to FIG. 11A to FIG. 11D regarding operation of each unit in attaching the radiation image sensing unit 101. It should be noted that the radiation image sensing unit 101 described in FIG. 1 to FIG. 6 is shown as an example of the radiation image sensing unit 101.

First, FIG. 11A shows an initial state in which the radiation image sensing unit 101 is not attached to the tray 304. In a case of attaching the radiation image sensing unit 101 from this initial state, as shown in FIG. 11B, the end portion of the secured housing unit 108 is placed on the lower unit securing panel 306 and the lower unit securing panel 306 is pushed downward. In a state in which the lower unit securing panel 306 has moved downward, the movable sidewall unit 109 side of the radiation image sensing unit 101 fits into the upper unit securing panel 305. When the radiation image sensing unit 101 is let go at the time point when it has become parallel with the tray 304, the radiation image sensing unit 101 is lifted upward by the spring force and achieves the state shown in FIG. 11C. Furthermore, at the same time as this, the lock mechanism unit 111 of the radiation image sensing unit 101 is released by the lock release shaft 307 and the movable sidewall unit 109 becomes movable. Due to this, the radiation image sensing unit 101 is lifted farther upward and the movable sidewall unit 109 is pressed inside the secured housing unit 108. Then it is secured in the state shown in FIG. 11D where there is a short distance from the sidewall to the radiation detection panel 103.

In a state in which the radiation image sensing unit 101 is secured in the tray 304, by storing the accommodation unit 302 in the tray 304, the radiation image sensing unit 101 having a slim bezel on top is positioned inside the upright imaging device 301. With the upright imaging device 301, chest region imaging is carried out in a state in which the chin of the examinee is placed on top of the accommodation unit 302. At this time, when the imaging-capable region is away from the position of the chin, the upper area of the examination position is undesirably removed from imaging or the examinee is forced into an uncomfortable posture. With the present embodiment, this problem is mitigated since it is possible to use a slim bezel imaging device.

Furthermore, in a case where the radiation image sensing unit 101 is again to be taken out of the accommodation unit 302, it can be taken out easily through performing this procedure in reverse. At this time, in cooperation with the removing operation, the movable sidewall unit 109 of the radiation image sensing unit 101 returns to the portable imaging state away from the radiation detection panel 103.

In this way, with the second embodiment, the change from a structure having resistance against external force during portable imaging to a slim bezel structure is carried out in cooperation with mounting the radiation image sensing unit, and therefore improvements in work performance can be achieved. Furthermore, it is possible to prevent human error such as dropping caused by moving [the unit] while it is in a slim bezel state, and the reliability of the portable radiation detection unit can be improved.

### Third Embodiment

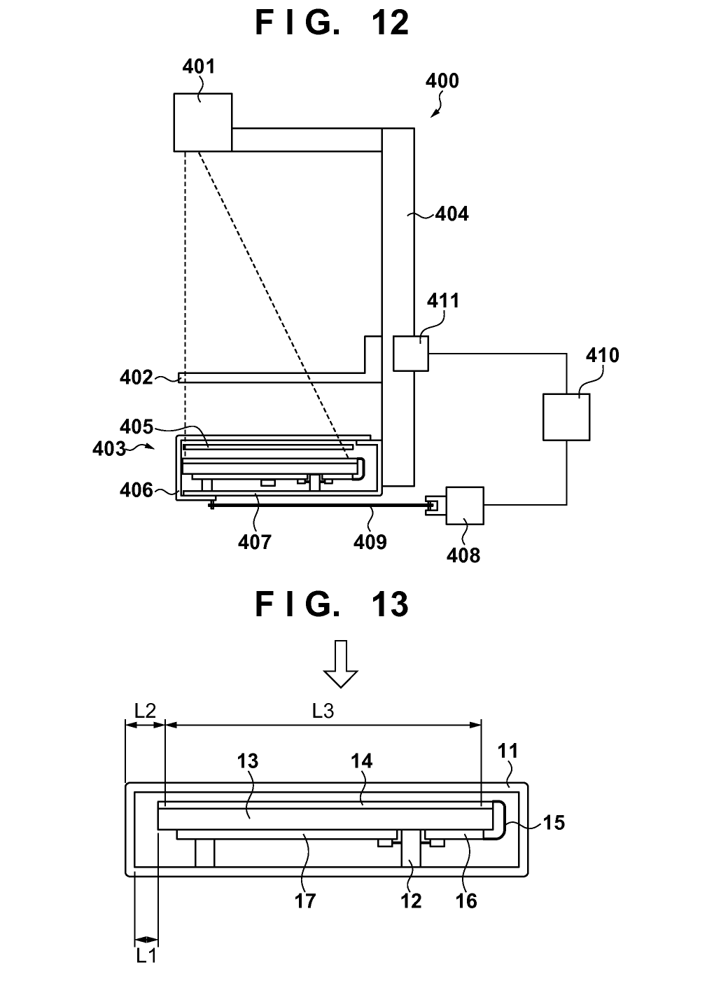

Description is given with reference to FIG. 12 regarding a third embodiment of the present invention. FIG. 12 is a configuration diagram of a portable radiation detection unit according to the third embodiment and shows a configuration example in which the radiation image sensing unit is inserted into a mammography device.

The second embodiment is configured such that the radiation image sensing unit is removable from the portable radiation detection unit, and the gap between the housing sidewall and the radiation detection panel varies in cooperation with attachment and removal. With the third embodiment, the radiation image sensing unit stays in a state in which it is inserted into the portable radiation detection unit and attachment and removal are not carried out. A point of difference is that a configuration is provided in which the state of the portable radiation detection unit is detected and the sidewall of the housing is moved in accordance with a detection result thereof, and the gap between the housing sidewall and the radiation detection panel is varied.

In FIG. 12, a mammography device 400 functions as the portable radiation detection unit and is provided with an X-ray tube 401, a pressing panel 402, a mammography image sensing unit 403, and a frame 404 to support these. Mammography is carried out by irradiating radiation from the X-ray tube 401, which is position at an upper area, in a state in which a breast of the examinee is sandwiched between the pressing panel 402 and the mammography image sensing unit 403.

The mammography image sensing unit 403 can use a similar structure as the radiation image sensing unit 101 shown in FIG. 7. However, a movement grid 405 is arranged inside the housing such that a function for eliminating unnecessary scattered rays is inbuilt. The housing is provided with a movable housing unit 406 and a secured housing unit 407, and the movable housing unit 406 is slidable against secured housing unit 407 such that its horizontal distance with respect to the radiation detection panel can be varied. In a same manner as the configuration shown in FIG. 7, the movable housing unit 406 is constituted by a uniform member having good radiolucency properties such as CFRP or the like from the radiation incident surface to a corner area where the sidewall and the radiation incident surface join. Due to this, imaging is possible up to a vicinity of the chest wall during mammography.

An actuator 408 is a drive source that causes the position of the movable housing unit 406 to change. The actuator 408 and the movable housing unit 406 are connected by a coupling member 409, and the position of the movable housing unit 406 switches according to ON/OFF operation of the actuator 408. For example, this can be configured such that, in an initial state, the movable housing unit 406 is put into a state away from the panel due to an elastic force of a spring, and the coupling member 409 constituted by a wire is pulled according to the ON of the actuator 408 constituted by a solenoid, thereby moving the movable housing unit 406 to a slim bezel position. The ON/OFF operations of the actuator 408 are carried out by a control unit 410.

Furthermore, the pressing panel 402 moves in an up or down direction against the frame 404 to sandwich the breast of the examinee. The pressing panel 402 is positioned above during standby, and moves below during imaging. A vertical position detector 411 detects the vertical direction position of the pressing panel 402. A detection result of the vertical position detector 411 is outputted to the control unit 410.

With the thus-configured mammography device 400, in an initial state prior to imaging, the pressing panel 402 is above and the movable housing unit 406 is retracted to a position away from the radiation detection panel. In this state, the vertical position detector 411 is in an OFF state. In the event of imaging, by moving the pressing panel 402 downward, the vertical position detector 411 turns ON, and a signal indicating an imaging-capable state is sent to the control unit 410. The control unit 410 drives the actuator 408 to cause the movable housing unit 406, which is the first housing portion, to move to the radiation detection panel side (the second housing portion side). Due to this, the mammography image sensing unit 403 is put into a slim bezel state. That is, movement of the movable housing unit is controlled in accordance with a determination of whether or not there is a state in which radiation imaging is possible.

As described above, in a state in which imaging is not being performed, a gap is provided between the radiation detection panel and the housing, and damage to the radiation detection panel is mitigated even if unforeseen shock is applied to the imaging device. On the other hand, during imaging, a slim bezel is achieved and imaging becomes possible right up to the chest wall.

Furthermore, in a case of mounting a mammography device in an examination vehicle, which is increasing in recent years, this movement is effective as a protective structure of the imaging device. Using this structure, the load exerted on the radiation detection panel from vibration and shock during movement of the examination vehicle can be reduced.

It should be noted that description up to this point has been description of a configuration in which the position of the sidewall varies in accordance with the position of the pressing panel, but it is also possible to carry out control according to a result of detecting a different state of the imaging device. Furthermore, a configuration can be achieved in which the ON/OFF of the power supply of the imaging device is used directly to drive the actuator, thereby switching the position of the sidewall.

The present invention is able to provide a portable radiation detection unit capable of supporting both portable imaging in which shock resistance is required and imaging in which a slim bezel is required.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-267259 filed on Dec. 6, 2011, which is hereby incorporated by reference herein in its entirety.

What is claimed is:

1. A portable radiation detection unit comprising a radiation detection panel that detects radiation and a housing that contains the radiation detection panel,
wherein the housing comprises a first housing portion, which includes at least one sidewall, and a second housing portion, which is independent from the first housing portion, and
by using a configuration in which the first housing portion is movable with respect to the second housing portion, a distance between the sidewall of the first housing portion and an end portion of the radiation detection panel provided in the second housing portion is variable.

2. The portable radiation detection unit according to claim 1,
wherein the radiation detection panel has a rectangular shape and, of four end portions of the radiation detection panel, a flexible printed circuit board is not connected to the end portion of the radiation detection panel where the distance is variable, and the flexible printed circuit board is connected to at least one of a remaining end portion.

3. The portable radiation detection unit according to claim 1,
wherein the first housing portion further comprises a housing configuration wall that includes a radiation incident surface.

4. The portable radiation detection unit according to claim 1,
wherein the housing further comprises a lock mechanism that secures a position of the first housing portion against the second housing portion.

5. The portable radiation detection unit according to claim 1,
wherein the second housing portion further comprises an elastic member that biases the first housing portion.

6. The portable radiation detection unit according to claim 5,
wherein the portable radiation detection unit further comprises an accommodation unit configured to detachably accommodate the housing,
configured such that in a state in which the housing is mounted in the accommodation unit and the first housing portion is being pressed by the accommodation unit, the first housing portion moves so that the sidewall of the first housing portion and the end portion of the radiation detection panel achieve a first distance, and
in a state in which the housing is taken out from the accommodation unit and the first housing portion is not being pressed by the accommodation unit, the first housing portion moves due to a biasing force of the elastic member to achieve a second distance longer than the first distance.

7. The portable radiation detection unit according to claim 1, further comprising:
a driving unit configured to move the first housing portion,
a detection unit configured to detect whether or not the portable radiation detection unit is in an imaging-capable state, and
a control unit configured to perform control in accordance with a detection result of the detection unit such that in a case where the portable radiation detection unit is not in the imaging-capable state, operation of the driving unit is controlled so that the sidewall of the first housing portion and the end portion of the radiation detection panel achieve a first distance, and in a case where the portable radiation detection unit is in the imaging-capable state, operation of the driving unit is controlled so that the sidewall of the first housing portion and the end portion of the radiation detection panel achieve a second distance shorter than the first distance.
